(19) United States
(12) Patent Application Publication
(10) Pub. No.: US 2007/0174982 A1
(43) Pub. Date: Aug. 2, 2007

(54) Brush holding device for a wafer cleaning brush

(76) Inventor: Chen-Ju Lin, Tainan Hsien (TW)

Correspondence Address: LADAS & PARRY, 5670 WILSHIRE BOULEVARD, SUITE 2100, LOS ANGELES, CA, 90036-5679, US

(21) Appl. No.: 11/342,083

(22) Filed: Jan. 27, 2006

(51) Int. Cl. B08B 1/04

(52) U.S. Cl. 15/77; 15/88.3; 15/21.1

(57) ABSTRACT

A brush holding device includes first and second holders to respectively hold two ends of a brush mandrel of a wafer cleaning brush. The second holder includes a second housing, a second inner case mounted inside the second housing, a second bearing unit mounted inside the second inner case, and a hollow second shaft journaled in the second bearing unit and having a cleaning liquid passage. The second inner case is made of plastic, such as, polyformaldehyde, and has a retaining part extending around and projecting outwardly from an outer peripheral surface of the second inner case to contact an inner peripheral surface of the second housing. The retaining part is formed as one piece with the second inner case.

### BACKGROUND OF THE INVENTION

1. Field of the Invention

The invention relates to abrush holding device, more particularly to a brush holding device for holding and rotating a wafer cleaning brush.

2. Description of the Related Art

After wafers are subjected to a chemical mechanical polishing process, micro-contaminants, such as microparticles of polishing agents and insulation layers and metal ions, are usually left over the surface of the wafers. In order to prevent such contaminants from affecting subsequent wafer processing steps, it is necessary to carry out a washing and cleaning process to remove the contaminants from wafers. Referring to FIG. 1, a wafer cleaning apparatus typically includes a washing room (not shown) and a washing brush 2 that operates in association with water and a chemical cleaning solution. The cleaning solution basically contains chemicals, such as hydrogen fluoride, ammonium hydroxide, etc. The brush 2 has a brush mandrel 21 provided with a plurality of bristles 22. During the washing operation, the bristles 22 are placed in direct contact with a wafer 1 to brush and remove the contaminants from the wafer 1.

A conventional brush holding device for holding the brush 2 includes first and second holders 3, 4 that are used to hold two opposite ends of the brush mandrel 21. The first holder 3 includes a first housing 31, a first bearing unit 32 disposed inside the first housing 31, a first shaft 33 journaled in the first housing 31, a first guide drum 34 sleeved on the first shaft 33, and a belt wheel 35 connected to the first guide drum 34.

The first bearing unit 32 includes a metallic first inner case 321 mounted inside the first housing 31, and two spaced apart first bearing assemblies 322 disposed inside the first inner case 321. Since the first bearing assemblies 322 are inserted into the first inner case 321, the first inner case 321 must be made of metal which is strong enough to bear torsional forces coming from the first shaft 33 that is inserted into the two bearing members 322. The first guide drum 34 is used to connect with one end of the brush mandrel 21.

The second holder 4 includes a second housing 41, a second bearing unit 42 disposed inside the second housing 41, a second shaft 43 journaled in the second bearing unit 42 to rotate relative to the second housing 41, and a second guide drum 44 sleeved onto the second shaft 43.

The second bearing unit 42 includes two spaced apart second bearing assemblies 423 mounted inside a metallic second inner case 422. The second inner case 422 is fitted in a retaining ring 421 which in turn is inserted into the second housing 41. The retaining ring 421 is in sealing contact with an inner wall of the second housing 41 and serves to retain the second inner case 422 in the second housing 41. The second inner case 422 functions to provide sufficient supporting strength to the second bearing assemblies 423 and thus is made of metal. The second shaft 43 is inserted into the two second bearing assemblies 423 so as to rotate relative to the second housing 41. The second guide drum 44 is used to connect with another end of the brush mandrel 21.

When the belt wheel 35 is rotated by a belt, the first shaft 33 is rotated so that the brush 2 wipes out the contaminants from the surface of the wafer 1. The cleaning liquid is sprayed onto the wafer 1 while the brush 2 is wiping the wafer 1.

Since the retaining ring 421 and the second inner case 422 are separate components, the retaining ring 421 is likely to displace because of vibrations due to the rotation of the first and second shafts 33, 43 and the brush mandrel 21 during the operation of the wafer cleaning apparatus. In addition, because the hardness of the retaining ring 421 is smaller than the second inner case 422, the retaining ring 421 is prone to wearing caused by the relative displacement of the second inner case 422 and the retaining ring 421. As a result, the second inner case 422 will become loosened and vibrate, resulting in unstable rotation of the second shaft 43. The rotation of the brush 2 will thus become abnormal, leading to the production of defects in the wafers. On the other hand, the cleaning liquid is likely to back up between the retaining ring 421 and the second inner case 422 which are separated from each other and corrode the component parts inside the second holder 4.

Furthermore, the first and second inner cases 321 and 422 which are made of metal are liable to be corroded by acidic substances coming from the cleaning liquid. Metal particles resulting from corrosion can contaminate the cleaning liquid inside the cleaning room and are therefore deleterious to the cleaning process.

### SUMMARY OF THE INVENTION

Therefore, the main object of the present invention is to provide a brush holding device with an improved construction which can reduce wear caused to the component parts of the holding device and an incidence of producing contaminating particles.

According to this invention, a brush holding device for holding and rotating a brush mandrel of a wafer cleaning brush, comprises a first holder, a drive unit and a second holder. The first holder is adapted to hold and rotate one end of the brush mandrel, and has a first housing with an inner peripheral surface, a first inner case that is mounted inside the first housing, a first bearing unit mounted inside the first inner case, and a first shaft journaled in the first bearing unit. The drive unit is connected to the first holder.

The second holder is adapted to hold the other end of the brush mandrel, and has a second housing, a second inner case that is mounted inside the second housing, a second bearing unit mounted inside the second inner case, and a hollow second shaft journaled in the second bearing unit and having a cleaning liquid passage axially extending therein.

The second housing further has an inner peripheral surface. The second inner case has two axially opposed ends and an outer peripheral surface disposed between the axially opposed ends and confronting the inner peripheral surface of the second housing. The outer peripheral surface is spaced apart from the inner peripheral surface and has a retaining part extending around the outer peripheral surface between the axially opposed ends and projecting outwardly from the outer peripheral surface to contact the inner peripheral surface. The retaining part is formed as one piece with the second inner case.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional brush holding device;

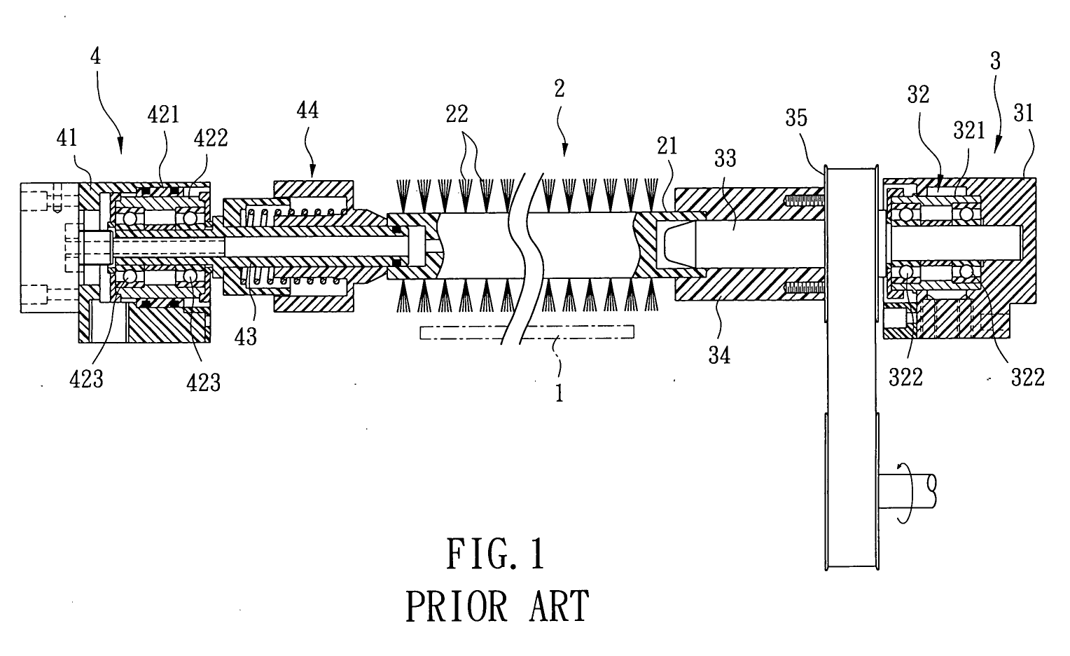

FIG. 2 is a sectional view of a brush holding device according to the present invention;

FIG. 3 is an exploded view showing a first holder of the brush holding device of FIG. 2; and

FIG. 4 is an exploded view showing a second holder of the brush holding device of FIG. 2.

### DETAILED DESCRIPTION OF THE PREFERRED EMBODIMENT

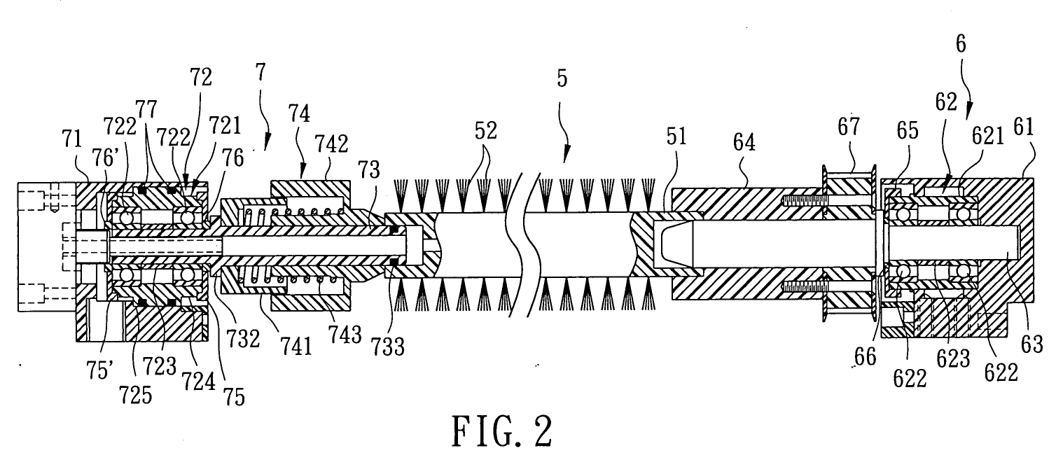

Referring to FIG. 2, there is shown a brush holding device according to a preferred embodiment of the present invention, which can be used to hold and rotate an elongated wafer cleaning brush 5. The wafer cleaning brush 5 includes a brush mandrel 51 provided with a plurality of bristles 52 to brush out contaminant particles adhering to the surface of a wafer.

The brush holding device includes a first holder 6 to hold and rotate one end of the brush mandrel 51, and a second holder 7 to hold another end of the brush mandrel 51. While a pair of first and second holders 6 and 7 is used to hold one wafer cleaning brush 5 in this embodiment, it is possible to use more than one pair, i.e. two or three pairs of the first and second holders 6 and 7 to hold more than one wafer cleaning brush to clean two surfaces of a single wafer at one time in order to save time.

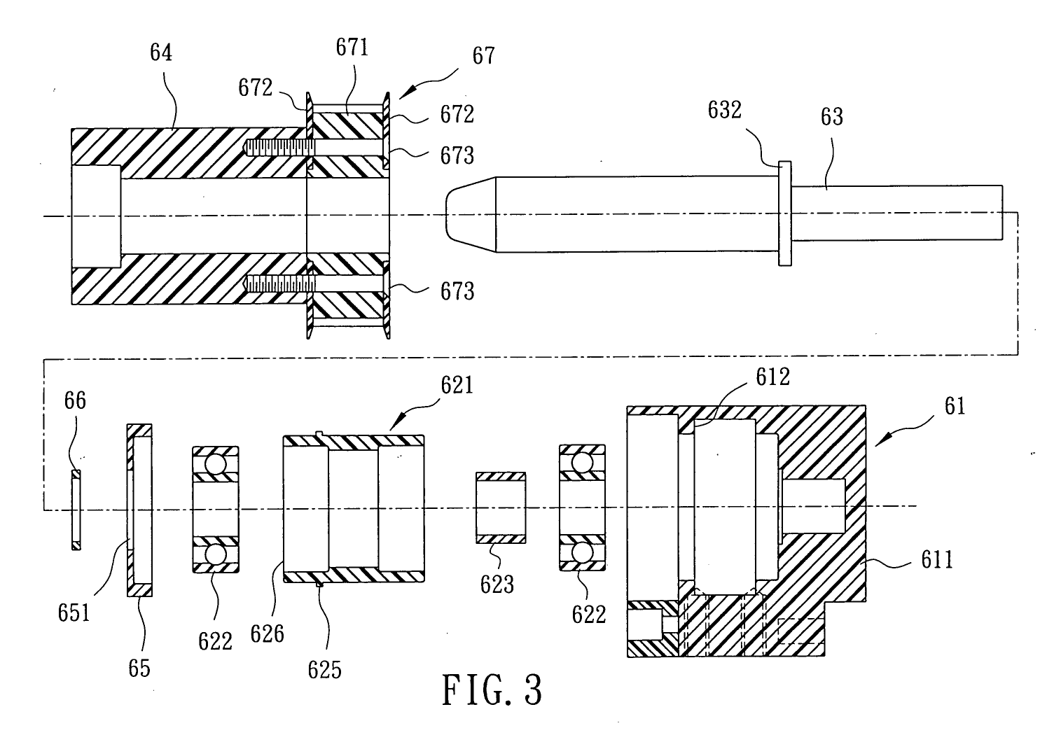

Referring to FIG. 3 in combination with FIG. 2, the first holder 6 includes a first housing 61, a first inner case 621 mounted inside the first housing 61, a first bearing unit 62 including a pair of first bearing assemblies 622 disposed inside the first inner case 621, a spacer 623 disposed between the first bearing assemblies 622, a first shaft 63 having one end journaled in the first bearing assemblies 622, and a bushing 64 fixed to the first shaft 63 and connected removably to the brush mandrel 51. A drive mechanism for driving the first holder 6 includes a belt wheel 67 that is secured to the bushing 64.

The first housing 61 includes a sleeve body 611 which has a closed end, an open end, an inner peripheral surface extending between the closed and open ends, and an annular retaining ring 612 projecting inwardly from the inner peripheral surface of the sleeve body 611.

The first inner case 621 is made of a plastic material which has high mechanical performance. Preferably, the first inner case 621 is made of polyfomaldehyde (POM) which has high stiffness and high hardness and whose strength and stiffness are substantially as high as that of a metal. Polyformaldehyde also has good abrasion resistance, high chemical resistance and self-lubricating characteristics. Instead of using polyformaldehyde, other plastics, such as, nylon, polypropylene (PP), polyethylene (PE), acrylonitrile-butadiene-styrene (ABS), and polyvinyl chloride (PVC), may be used for fabricating the first inner case 621.

A first cover 65 is disposed around the first shaft 63 and covers an outer end 626 of the first inner case 621. A first seal ring 66 is disposed within a central hole 651 of the first cover 65 and projects slightly out of the central hole 651. Furthermore, the first seal ring 66 is sleeved around the first shaft 631 between a rim 632 of the first shaft 63 and one of the first bearing assemblies 622. The rim 632 abuts against the first seal ring 66.

The belt wheel 67 has a cylindrical wheel body 671 disposed between two opposite wheel rims 672. Fasteners 673 are used to secure the wheel body 671 and the wheel rims 672 to the bushing 64. The wheel body 671 is further fastened to the first shaft 63 through an insert pin (not shown). In use, a belt (not shown) is mounted on the belt wheel 67 and connects the belt wheel 67 to a drive unit (not shown) so that the first shaft 63 is driven by the drive unit through the belt and the belt wheel 67.

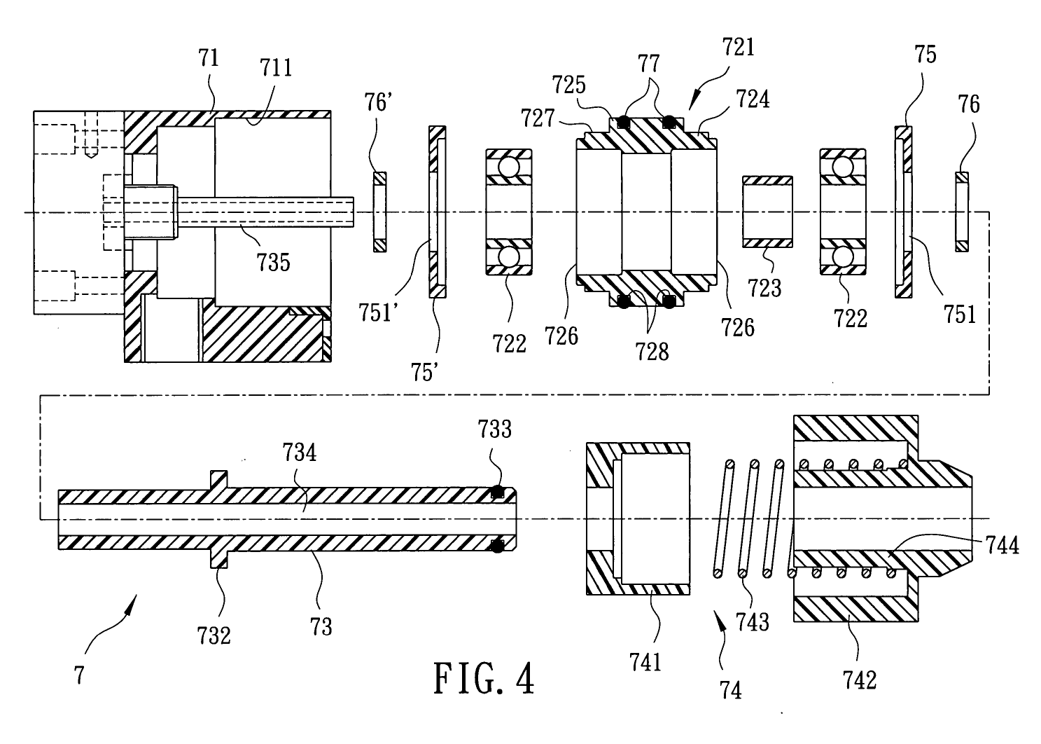

Referring to FIG. 4 in combination with FIG. 2, the second holder 7 includes a second housing 71, a second inner case 721 mounted inside the second housing 71, a second bearing unit 72 having a pair of second bearing assemblies 722 mounted inside the second inner case 721, a spacer 723 disposed between the second bearing assemblies 722, and a second shaft 73 journaled in the second bearing assemblies 722.

The second inner case 721 includes a tubular case 724 having two axially opposed open ends 726, and an outer peripheral surface 727 between the opposed open ends 726 and confronting an inner peripheral surface 711 of the second housing 71. The outer peripheral surface 727 is spaced apart from the inner peripheral surface 711 and has a retaining part 725 extending around and projecting outwardly from the outer peripheral surface 727 to contact the inner peripheral surface 711 of the second housing 71. The retaining part 725 is formed as one piece with the tubular case 724. Two O-rings 77 are provided respectively in two annular grooves 728 formed in an outer surface of the retaining part 725 to contact tightly against the inner peripheral surface 711 of the second housing 71. Like the first inner case 621, the second inner case 721 is made of a plastic material of high mechanical performance, preferably, polyformaldehyde (POM).

The second bearing assemblies 722 are mounted inside the tubular case 724 and are spaced apart from each other by the spacer 723. The second shaft 73 is made hollow so as to form a cleaning liquid passage 734. The second shaft 73 is further provided with an annular flange 732 and a sealing ring 733. A tube 735 is inserted into the second shaft 73 and is communicated fluidly with the cleaning liquid passage 734. The tube 735 is used to connect with a cleaning liquid supply (not shown).

The second holder 7 further includes a biasing unit 74 disposed proximate to the second housing 71 for biasing the second shaft 73 toward the first shaft 63. The biasing unit 74 includes a first housing sleeve 741 inserted telescopically into a second housing sleeve 742. The second housing sleeve 742 has a hollow core 744. The second shaft 73 is inserted into the second bearing assemblies 722 on one side of the annular flange 732 and extends through the first and second housing sleeves 741, 742 on the other side of the annular flange 732. Inside the second housing sleeve 742, the second shaft 73 passes slidably through the hollow core 744. A helical spring 743 is disposed within the first and second housing sleeves 741, 742 and around the second shaft 73.

Two covers 75, 75′ are disposed around the second shaft 73 to cover respectively the two open ends 726 of the second inner case 721 so as to retain the two second bearing assemblies 722 inside the second inner case 721. Each cover 75, 75′ has a central hole 751, 751′. The cover 75 is disposed adjacent to the annular flange 732, and a seal ring 76 is fitted into the central hole 751 of the cover 75 so that the seal ring 76 abuts against the annular flange 732. Another seal ring 76′ is fitted in the central hole 751′ of the cover 75′ and around the second shaft 73.

Since the second inner case 721 which has the integral retaining part 725 projecting from the second inner case 721 is used in place of a combination of the separate second inner case 422 and retaining ring 421 used in the prior art, the problem of wear due to relative displacement of components as encountered in the prior art may be alleviated. In addition, because the second inner case 721 is one piece with the retaining part 725, there is no gap for the cleaning liquid to back up therethrough so that the component parts inside the second housing 71 will not be corroded.

Moreover, with the use of the first and second inner cases 621, 721 which are made of plastic, especially, polyformaldehyde which has high mechanical strength and high resistance to chemicals or corrosion, the brush holding device of the present invention is durable and has a prolonged life. The frequency of maintenance and replacement of component parts in the brush holding device can thus be reduced.

While the present invention has been described in connection with what is considered the most practical and preferred embodiments, it is understood that this invention is not limited to the disclosed embodiment but is intended to cover various arrangement included within the spirit and scope of the broadest interpretation so as to encompass all such modifications and equivalent arrangements.

I claim:

1. A brush holding device for holding and rotating a brush mandrel of a wafer cleaning brush, comprising:
a first holder adapted to hold and rotate one end of the brush mandrel, said first holder having a first housing with an inner peripheral surface, a first inner case that is mounted inside said first housing, a first bearing unit mounted inside said first inner case, and a first shaft journaled in said first bearing unit;
a drive unit connected to said first holder; and
a second holder adapted to hold the other end of the brush mandrel, said second holder including a second housing, a second inner case that is mounted inside said second housing, a second bearing unit mounted inside said second inner case, and a hollow second shaft journaled in said second bearing unit and having a cleaning liquid passage axially extending therein,
said second housing having an inner peripheral surface, said second inner case having two axially opposed ends and an outer peripheral surface disposed between said axially opposed ends and confronting said inner peripheral surface of said second housing, said outer peripheral surface being spaced apart from said inner peripheral surface and having a retaining part that extends around said outer peripheral surface between said axially opposed ends and that projects outwardly from said outer peripheral surface to contact said inner peripheral surface of said second housing, said retaining part being formed as one piece with said second inner case.

2. The brush holding device of claim 1, wherein said retaining part has two spaced apart annular grooves, and two O-rings respectively received in said annular grooves, said O-rings contacting said inner peripheral surface of said second housing.

3. The brush holding device of claim 1, wherein said first inner case is made of plastic.

4. The brush holding device of claim 1, wherein said first inner case is made of polyformaldehyde.

5. The brush holding device of claim 1, wherein said second inner case is made of plastic.

6. The brush holding device of claim 1, wherein said second inner case is made of polyformaldehyde.

7. The brush holding device of claim 1, further comprising a biasing unit disposed around said second shaft and proximate to said second holder.
